(19) United States
(12) Patent Application Publication
(10) Pub. No.: US 2007/0028222 A1
(43) Pub. Date: Feb. 1, 2007

(54) Free/outer variable capture

(75) Inventors: Henricus Johannes Maria Meijer, Mercer Island, WA (US); Anders Hejlsberg, Seattle, WA (US); Matthew J. Warren, Redmond, WA (US); Luca Bolognese, Redmond, WA (US); Peter A. Hallam, Seattle, WA (US); Gary S. Katzenberger, Woodinville, WA (US); Dinesh C. Kulkarni, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/193,566

(22) Filed: Jul. 29, 2005

(51) Int. Cl. G06F 9/45

(52) U.S. Cl. 717/140; 717/151

(57) ABSTRACT

This disclosure concerns various manners and mechanisms to capture and interact with free/outer variables or parameters. The capture of such variables, among other things, enables the code to become mobile to facilitate transmission to and execution by various systems or sub-systems. Transmission can be accomplished, for instance, by generation of code objects or data packets that include substituted values of the free variables and/or references to the location of the values.

### CROSS-REFERENCE TO RELATED APPLICATIONS

This application is related to U.S. Patent Application Serial No. filed Jul. 29, 2005, entitled LAMBDA EXPRESSIONS [Ref: MS313313.01/MSFTP1050US], and U.S. Patent Application Serial No. filed Jul. 29, 2005, entitled COMPILER SUPPORTING PROGRAMS AS DATA OBJECTS [Ref: MS312775.01]. The entireties of these applications are incorporated herein by reference.

### BACKGROUND

Programming languages continue to evolve to facilitate specification by programmers as well as efficient execution. In the early days of computer languages, low-level machine code was prevalent. With machine code, a computer program or instructions comprising a computer program were written with machine languages or assembly languages and executed by the hardware (e.g., microprocessor). These languages provided an efficient means to control computing hardware, but were very difficult for programmers to comprehend and develop sophisticated logic. Subsequently, languages were introduced that provided various layers of abstraction. Accordingly, programmers could write programs at a higher level with a higher-level source language, which could then be converted via a compiler or interpreter to the lower level machine language understood by the hardware. Further advances in programming have provided additional layers of abstraction to allow more advanced programming logic to be specified much quicker then ever before. However, these advances do not come without a processing cost.

Compilers and/or interpreters bear the burden of translating high-level logic into executable machine code. In general, a compilers and/or interpreters are components that receive a program specified in a source programming language (e.g., C, C#, Visual Basic, Java . . . ) and covert the logic provided thereby to machine language that is executable by a hardware device. However, the conversion need not be done verbatim. In fact, conventional compilers and/or interpreters analyze the source code and generate very efficient code. For example, programmers write code that sets forth a logical flow of operations that is intuitive and easy for humans to understand, but is often inefficient for a computer to execute. Compilers and/or interpreters can identify inefficiencies and improve program performance at the hardware level by eliminating unnecessary operations and/or rearranging the execution of instructions while still achieving the intended results. In this manner, programmers can create robust and efficient software programs.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, systems and methods are provided concerning free or outer variables. More specifically, a myriad of strategies are disclosed for capture of free variables or parameters within programmatic constructs including but not limited to lambda expressions. For example, identified free variables can be captured by value as well as by reference. Furthermore, groups or sub-expressions of one or more free variables can be captured.

In accordance with a particular disclosed aspect, free variables or parameters can be captured within code objects or data packets that can be transmitted to other computing systems or sub-systems. These objects can include expression trees with one or more captured free variables. Those free variables captured by reference can call back to another system or sub-system to request and receive the value or state of a variable or alternatively modify or update the variable, for example at execution time.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a free variable interaction system.

FIG. 2 is a block diagram of a capture component.

FIG. 3 is a block diagram of a free variable capture system.

FIG. 4 is a block diagram of a mobile code system.

FIG. 5 is a block diagram of an object execution system.

FIG. 6a is a block diagram of an expression-tree interaction system.

FIG. 6b is a block diagram of an expression-tree interaction system.

FIG. 7 is a flow chart diagram of a method for interacting with free/outer variables.

FIG. 8 is a flow chart diagram of a method for capturing free variables.

FIG. 9 is a flow chart diagram of a mobile object interaction methodology.

FIG. 10 is a flow chart diagram of a method of employing a mobile object.

FIG. 11 is a schematic block diagram of an exemplary compilation environment.

FIG. 12 is a schematic block diagram illustrating a suitable operating environment.

FIG. 13 is a schematic block diagram of a sample-computing environment.

### DETAILED DESCRIPTION

The various aspects of the subject invention are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

As used herein, the terms “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

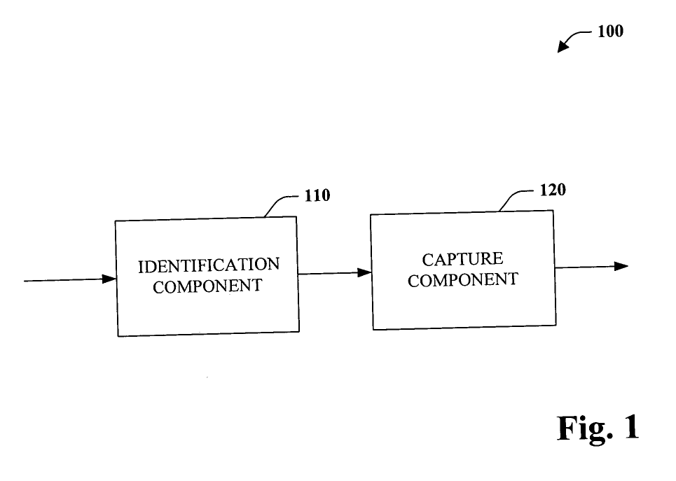

Turning initially to FIG. 1, a free variable interaction system 100 is depicted. The free variable interaction system 100 includes an identification component 110 and a capture component 120. Identification component 110 receives programmatic code and identifies, spots or otherwise detects free or outer variable(s) that are specified within the scope of a programmatic construct such as an expression. A free or outer variable is any variable or parameter that is defined and/or declared outside another program construct(s). Consider the following non-limiting exemplary code:

int x = 35;
Func<int, bool> f = |y| y > x;

In this example, a local variable or parameter “x” is declared to be of type integer and assigned the value of 35. In addition, a lambda expression is defined as “|y| y >x” and assigned to the function, delegate or anonymous method Func<int, bool>f that receives an integer and returns a Boolean value (e.g., true/false, on/off, 1/0 . . . ). Specifically, the lambda expression and the assigned function receive a value represented by variable parameter “y,” compare it with the value of variable “x,” and returns a Boolean value that identifies whether the value of “y” is greater than the value of “x.” The variable or parameter “x” is defined and declared as a local variable outside the lambda expression (int x=35), but is also within the scope of the lambda expression and its assignment to the function f. Accordingly, “x” is an identified free or outer variable in this example.

The identity of variables or parameters identified as free or outer variables are provided from the identification component 110 to the capture component 120. Capture component 120 captures one or more free or outer variables or parameters, for instance, associated with a lambda expression. Variables are referred to as outer or free variables as they are declared and/or defined outside a construct such as an expression. For example, the life of a normal bound variable is typically limited solely by the statement block with which it is associated. Upon complete execution of the statement block, the variable can be deleted and space for the variable released or de-allocated. However, where an outer or free variable is referenced by a programmatic construct such as a lambda expression, the outer variable is said to be captured by the expression and its lifetime is coupled to the lifetime of the capturing construct. The free or outer variable(s) can be captured by capture component 120 such that it is bound to the expression and under the control of the associated expression or assigned construct. It should be appreciated that capture of free variables can be accomplished in a variety of different manners all of which are considered within the scope of the subject disclosure.

Capture of free variables by capture component 120 can be by value or reference. If a free variable is captured by value, its value is retrieved and substituted for the variable. In the example supra, the value of the variable “x” be determined and substituted for the variable itself resulting in the following:

int x = 35;
Func<int, bool> f = |y| y > 35;

The variable “x” in the expression is replaced by its value “35.“Alternatively, the variable can be captured by reference to an instance of the variable. For example, this reference can be a pointer to the location (e.g., memory) that stores the value of the variable. In the ongoing example, special syntax can be utilized to denote that the value is captured by reference, such as but not limited to curly brackets. The resulting expression in this instance would be:

Func<int, bool> f = |y| y > {x};

This syntax can be utilized to invoke a method or function relative to the referenced variable that, among other things, return the value in a referenced memory location, for instance, at run time or compile time. Thus, capturing free variables by value captures the values of the variables at a particular time. It is a snapshot of the variable at the time the substitution is made. By contrast, capturing a variable by reference enables the variable to change over time and the value can be bound at runtime when needed, for instance, to evaluate an expression. As discussed in more detail infra, it should be noted that such a method or function could also be employed to modify or update the value of the free variable.

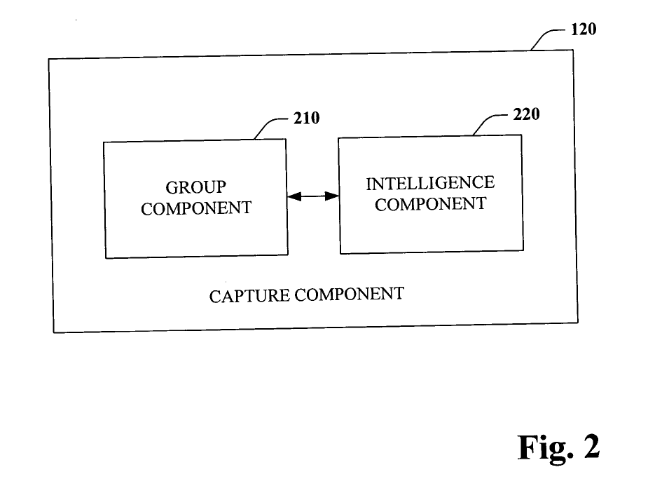

FIG. 2 illustrates a capture component 120 in further detail. Capture component 120 can include a group component 210 and an intelligence component 220. An expression may include more than one free or outer variables that are captured by capture component 210. Group component 210 can group various sub-expressions for capture including one or more free variables. Consider the following exemplary code:

int y = 1;
int z = 3;
int w = 5;
Func<int, int> g = |x| x + y + z * w;

Here, there is a function, delegate, or anonymous method g that receives an integer and generates an integer. The method g is assigned a lambda expression consisting of three free variables “y,” “z” and “w.” There are various different ways to deal with multiple free variables. For example, the minimal free variable sub-expression can be captured by group component 210. In other words, each individual variable can be captured by itself. For example, if the free variables were captured by reference the assignment would be:

Func<int, int> g = |x| x + {y} + {z}*{w};

In such a situation, the value of each of the variables or parameters would be received from memory at execution time to enable evaluation of the expression and generation of a result or output. Alternatively, the maximal free sub-expression could be captured. In this situation, the grouping component 210 would capture the largest possible sub-expressions that do not depend on the arguments of the expression. In such a case, the following could be generated:

Func<int, int>> g = |x| x + {y + z*w};

Here, the values of “y,” “z,” and “w” are grouped. The value of the each parameter can be can be determined and the calculation performed to resolve the value of the group. Subsequently, the resulting value can be passed back to the expression to be added with “x.” Still further yet, the grouping component 210 may group the free variables and sub-expressions some where between minimal and maximal. For instance, the grouping component can communicate with the intelligence component 220 to determine how to group the sub-expressions.

The intelligence component 220 can include heuristics and/or employ artificial intelligence or knowledge based systems, components, or mechanisms (e.g., explicitly and/or implicitly trained classifiers) to perform inference and/or probabilistic determinations and/or statistical-based determinations pertaining to groupings for example based on context including but not limited to system use, load, data access times, processing times, and the like. By way of example, the intelligence component 220 could determine that the sub-expression “z*w” should be grouped. Based on this suggestion, the grouping component can group this expression, for example, as follows:

Func<int, int>> g = |x| x + {y} + {z*w};

In this instance, the sub-expression “z*w” is grouped such that the value of the sub-expression is calculated and returned in place of” z*w.” Additionally, the value of variable y can be retrieved from memory and returned. The expression can then be computed based on the values of “x,” “y” and “z*w.” Furthermore, it should be noted and appreciated that grouping of components can enable parallel processing of expressions. For example, one portion of an expression can be evaluated while another portion is being evaluated and subsequently operations can be performed on the results of both. More specifically, in the example above if variable “y” was captured by value rather than reference, the computation of x +y could occur in parallel with the retrieval and processing of “z*w.” Subsequently, the values could be added together.

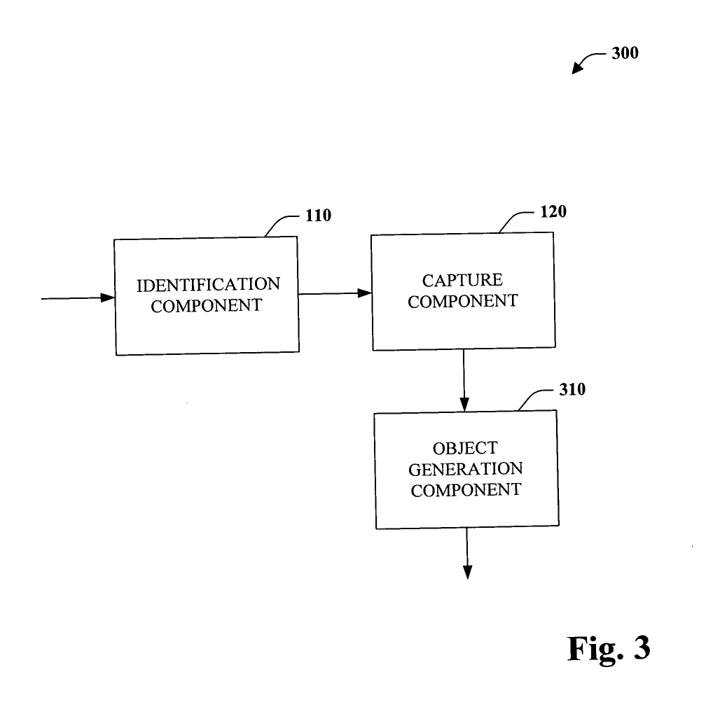

Referring to FIG. 3, a free or outer variable capture system 300 is illustrated. System 300 includes identification component 110, capture component 120 and object generation component 310. As described above, identification component receives an expression or other programmatic construct and provides a mechanism for identification of free or outer variables or parameters within the scope of a construct. The identity of these free variables can be transmitted to the capture component 120. Capture component 120 is a mechanism for capturing or binding the free variable to a particular programmatic construct such as an expression. Capture component 120 can capture variables by value or by reference. Capture by value applies a substitution of the value of the variable or parameter for the variable or parameter. As per capture by reference, the location of the value of the variable is provided in conjunction with the variable specification or as a substitution thereof. Furthermore, the capture component 120 could group of one or more free variables. Object generation component 310 receives a programmatic construct such as an expression with captured free variables and generates a code object. This object encapsulates the programmatic construct or code as a data packet that can be passed to other systems for execution. In one instance, the object can take the form of an expression tree but it is not limited thereto.

Programmatic code can indicate whether a code object is to be generated. For example, the following assignment statement assigns an expression tree that represents the lambda expression “|x| x >1” to an expression (e.g., object) of the function or delegate f:

Expression<Function<int, int>> f = |x| x > 1;

In this case, it would probably not be proper practice to hard code the integer into the lambda expression, so a free variable or outer variable can be captured in the code and the resulting object or expression tree. In the example infra, the lambda expression “|x| x +y” captures the outer variable “y”:

int y = 1;
Expression <Func<int, int>> g = |x| x + y;

As previously described, there are several strategies that can be employed by the capture component 120, which can be applied to the generated object. One way to capture the outer variables is by value. At the time an expression tree is created, for instance, all outer variables are evaluated and the resulting values are stored in the expression tree. In the above example that would mean that a tree would be constructed that includes the value “1” instead of the variable “y:”

int y = 1;
Expression <Func<int, int>> g = |x| x + 1;

An alternative is to capture a reference to the instance of the variable that is active at the time the object or expression tree is created. In that case, the question is how to represent such a reference in the expression tree. One possibility is to wrap the variable in a thunk or funclet, a small method or procedure that acts as a placeholder or proxy that when called or executed returns or modifies the value of the reference. The curly brackets “{}” can be utilized to denote the read-only funclet (Funclet) delegate (){return y;}

int y = 1;
Expression<Func<int, int>> g = |x| x + {y};

In this example, the outer variable is captured by an anonymous method funclet. Assume the statements appear inside a method F() inside a class C, then the following code would be generated:

```
class C
{
    class Closure
    {
      int y;
      object M(){ return y; }
    }
    void F( )
    {
    Closure e = new Closure( );
    e.y = 1;
    Expression<Function<int, int>> g = |x| x + new Funclet(e.M)
    }
}
```

The example above was rather simple and captured exactly the variable “y.” However, in many situations, the expression is more complicated and then the question becomes how to partition the object or expression tree. For example, take the following contrived example that captures two outer variables:

int y = 1;
int z = 3;
Expression<Func<int, int>> g = |x| x + y + h(z);

If the minimal free sub-expression is captured, just the individual outer variables themselves are captured, that is “|x|x+{y}+h({z}).” On the other hand, if the maximally free sub-expression is captured, the largest possible sub-expressions that do not depend on the arguments of the expression are captured in which case results in “|x|x+{y +h({z})}”.

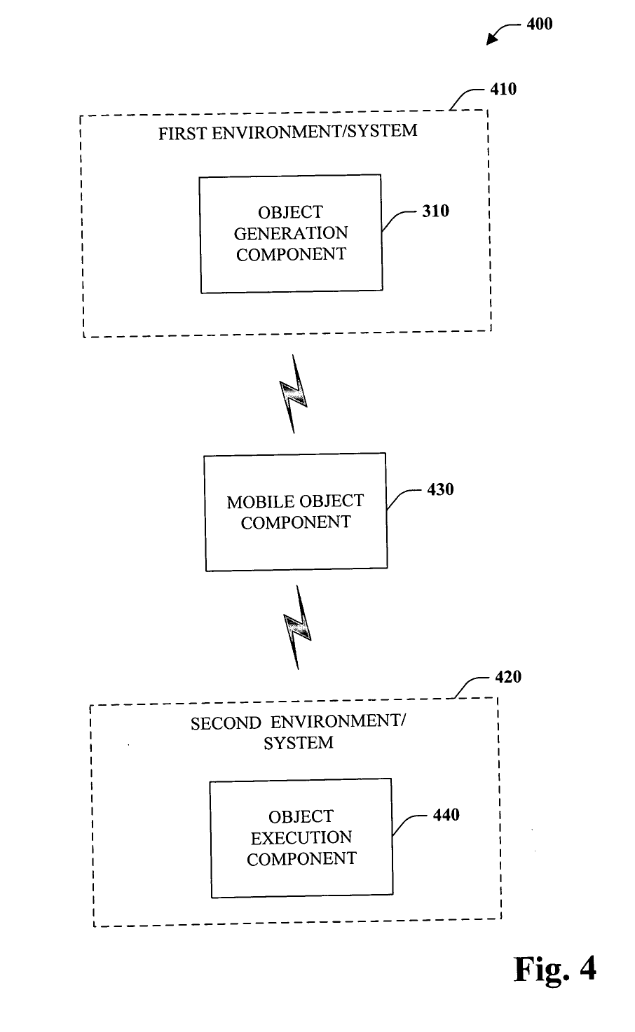

Turning to FIG. 4, a mobile code system 400 is illustrated. System 400 includes a first environment or system 410 and a second environment or system 420. Such environments 410 and 420 can reside on the same or different computer system, server, or the like. First environment 410 can include, among other things, object generation component 310 as described in FIG. 3. The object generation component 310 can generate an object, mobile object component, or data packet 430. The mobile object component 430 can include data and/or code, for example including captured free variables. In one instance, the mobile object component 430 can include an expression tree. The mobile object is transmitted from the first environment 410 to second environment 420. Transmission can be in any form of communication such as wired, wireless, network, bus, and the like. Second environment 420 can receive the mobile object component 430 sent from the first environment 410. Second environment 420 can also include, among other things, an object execution component 440 that can execute received mobile object components 430. By way of example and not limitation, the first environment 410 can be computer and the second environment 420 can be a database management system. The mobile object component 430 can correspond to an expression tree representing code, which can be executed by the execution component 440 to retrieve, provide, and/or otherwise manipulate data.

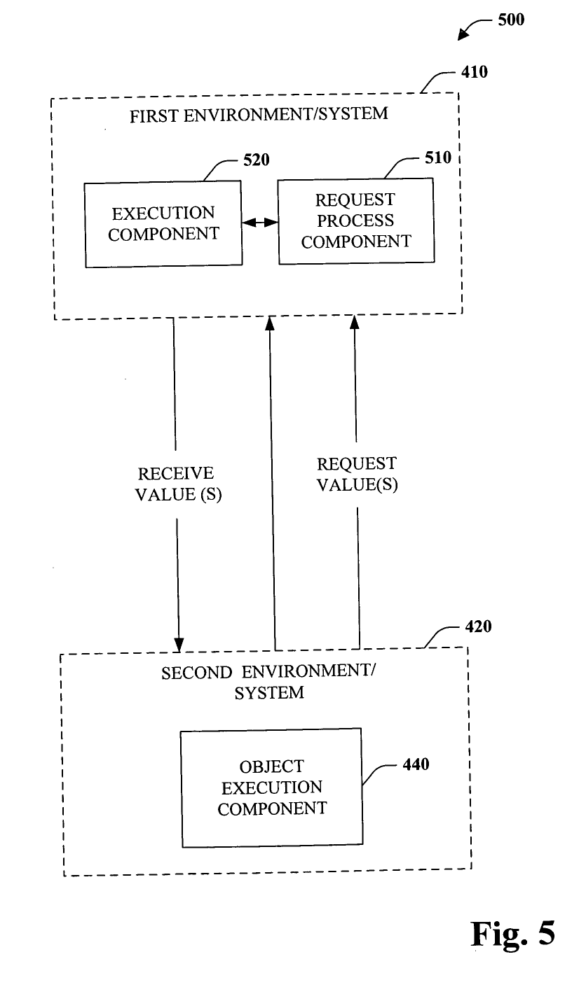

FIG. 5 depicts a system 500 for mobile object execution. Similar to system 400 of FIG. 4, system 500 includes a first environment or system 410 and a second environment or system 420. Second environment 420 includes an object execution component 440. The object execution component 440 can execute a mobile object component 430 (not shown) that corresponds to a piece of data that represents code. For instance, the object component 430 can be an expression tree. The object code 430 can include one or more captured free or outer variables or captured sub-expressions. Furthermore, such captured free variables could be captured by reference. During execution of the code captured by the object component or data packet, the code may call back to the first environment 410 to retrieve the state or modify the value of the captured free variable. As shown, a request for the value of a captured free variable or sub-expression can be communicated to the first environment 410. The first environment can include, among other things, a process component 510 that receives and process the request. For example, the process component 510 could retrieve one or more values from memory and perform a calculation if the request corresponds to a sub-expression. Subsequently, the process component 510 could transmit the value of the captured variable or sub-expression back to the second environment 420 and in particular the object execution component 440. The execution component 440 could then continue to execute the code utilizing the communicated value. Still further yet, the code could generate a result, which is passed back to the first environment 410 and an execution component 520. Accordingly, execution component 520 in a first environment 410 could execute a program that interacts with an object execution component 440 in a second environment 420. For example and not limitation, the C# program could transmit an expression tree to the second environment 420 that represents a data query. The object execution component 440 could interpret this expression tree, generate, and execute SQL statements on a database and return the results to the C# program being executed by execution component 520 in the first environment. Additionally or alternatively, it should be noted that the captured variable could be updated or modified rather than retrieved.

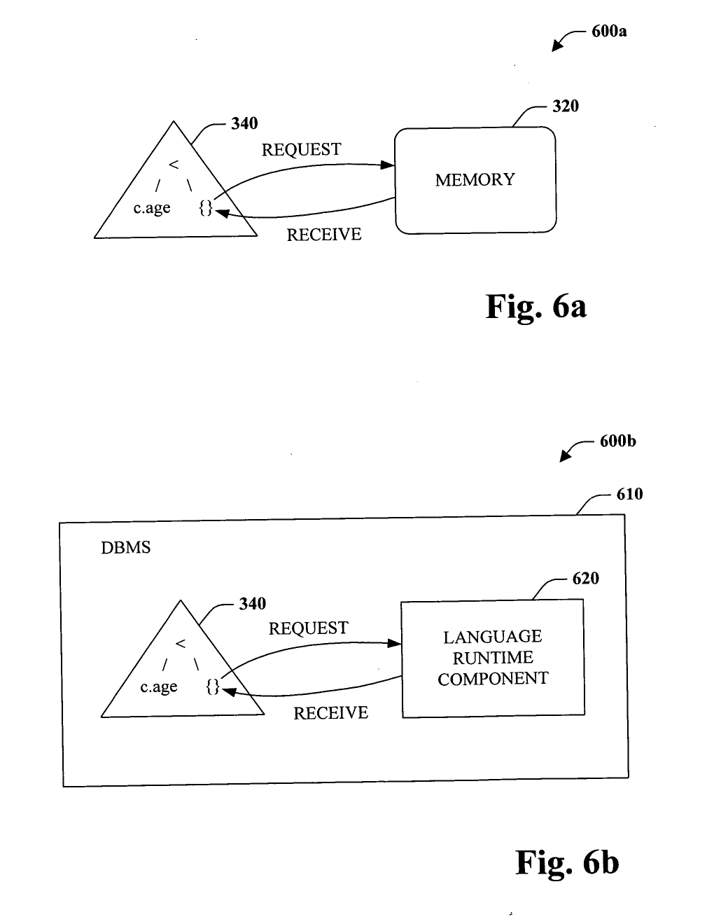

FIG. 6a and 6b are provided to facilitate understanding of particular implementations and uses of mobile object code or expression trees. These examples are not meant to limit the scope of the disclosed subject matter in any way. They are provided as exemplary implementations and provide only two of many, which will become evident to those of skill in the art open reviewing this detailed description.

FIG. 6a depicts an expression-tree interaction system 600a. As illustrated, an expression tree 340 and a computer readable memory 320 are provided. The expression tree 340 includes an expression with captured free variables. The expression tree 340 can include a mechanism or procedure to call back into memory to request and retrieve a value. Here, the expression is “c.age <{}” and the brackets indicate that a method is called that will request and retrieve the value of a captured variable such as “x” from the memory 320.

To further appreciate particular inventive aspects disclosed herein consider the following example:

IEnumerable<Customer> cs
cs.where(|c| c.age < 35)

The first statement says there is a collection of customers “cs.” The second statement says from that collection of customers, select a customer where their age is less than 35 and return it. This can be utilized to produce a collection of results such as IEnumerable of customer result:

IEnumerable<Customer> cs
IEnumerable<C> r = cs.where(|c| c.age < 35)

Basically what happens is the collection of customers is loaded in memory and the predicate c.age <35 is utilized to filter through the customers and return data regarding customers who are less than thirty five and throwing away the others that are equal to or greater than thirty five. It should be noted that everything happens in memory in this case.

Now say that the collection of customers is in a database external to memory in a customers table, for instance. What is desirous is to shift the filtering to the external database and simply return the results. To accomplish this code needs to be passed to the database so that it can execute this filtration. To execute such filtering in memory an expression can be expressed in terms of IEnumerable. For example:

IEnumerable<T> Where<T> (IEnumerable<T> src, Func <T, bool> p)
{...}

Therefore, it takes an IEnumerable source and filters the source with the predicate expressed as a function “Func” and returns a collection or IEnumerable of Customers. If the filtering is to be done externally, the expression can be expressed in terms of Query:

Query<T> Where<T> (Query<T> src, Expression<Func<T, bool>> p)
{...}

In this case, IEnumerable becomes Query and Func becomes an expression of Func. This expression is the object or a piece of data (e.g., expression tree) that represents that filtering code.

The filtering functionality can be captured by a lambda expression. For example:

Expression<Func<Customer, bool>> e = |c| c.age < 35;

Again, instead of Func this says generate an expression of Func. In particular, it can denote conversion of the lambda expression to an expression or object that represents the delegate, method, or function “e.”

FIG. 6a represents a situation where an expression tree representing a delegate, method, or function is provided external to the memory. Subsequently the expression tree 340 can interact with the memory 320 to retrieve free variables or sub-expressions captured by reference.

There are a number of situations or applications where such mobile code could be implemented. FIG. 6b represents one such scenario. Here, a database management system (DBMS) 610 is provided. Database management system can include both hardware and/or software to carry out such functionality. The DBMS 610 system can contain an expression tree 340 and a language runtime component 620. The runtime component 620 can provide a mechanism to generate, execute and support computer program applications written in one or a myriad of different languages. Accordingly, the runtime component can correspond but is not limited to the Common Language Runtime (CLR) or the Java Runtime Environment (JRE). Therefore, an expression 340 can be generated and passed to the DMBS 610, which can be compiled and/or translated into a database query language such as SQL (structured query language). During execution of the generated query statement, a call can be made back to the language runtime to retrieve or modify any free variables or sub-expressions captured by reference. Since the DMBS 610 can have the runtime component 620 tightly integrated therein, communication therebetween would not be especially expensive in terms of time and/or resources.

As noted, systems 600a and 600b are merely two specific examples of systems that utilize a mobile data object or expression tree with free variables. Additional systems will be appreciated by those of skill in the art upon reading of this specification. By way of example and not limitation, where a system includes a processor and a co-processor such as graphics co-processor, aspects of the disclosed subject matter can be employed. For instance, an expression tree can represent some rendering of a polygon that has free variables captured by reference. In such a scenario, the co-processor could call back to the main processor to obtain or modify a value of a free variable and/or sub-expression. Consequently, parallel processing is supported.

The aforementioned systems have been described with respect to interaction between several components. It should be appreciated that such systems and components can include those components or sub-components specified therein, some of the specified components or sub-components, and/or additional components. For example, a system could include object generation component 310, execution component 520, and request process component 510 or a combination thereof. Sub-components could also be implemented as components communicatively coupled to other components rather than included within parent components. Additionally, it should be noted that one or more components may be combined into a single component providing aggregate functionality. For instance, execution component 520 can include a request process component 510 rather than be communicatively coupled thereto. The components may also interact with one or more other components not specifically described herein but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. For example, intelligence component 220 could utilize artificial intelligence, machine learning or like mechanisms to facilitate identification of a proper grouping of free variables.

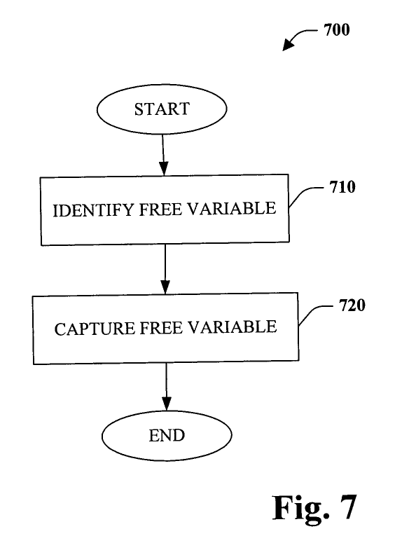

In view of the exemplary systems described supra, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media.

Turning to FIG. 7, a method 700 for interacting with free variables is provided. At reference numeral 710, one or more free/outer variables are identified within or specified with other programmatic constructs. Free variables are variables or parameters that are declared and defined outside a programmatic construct such as an expression. At 720, the free variables that are identified within the scope of other programmatic constructs can be captured. The variables can be captured by value and/or reference. A variable can be captured by value by substituting the value of the variable for the variable at a particular time such as upon generation of a mobile object or expression tree. Capture by reference involves replacing the variable with a callback mechanism, procedure, or reference thereto that can obtain and/or modify the value of the variable at an external source.

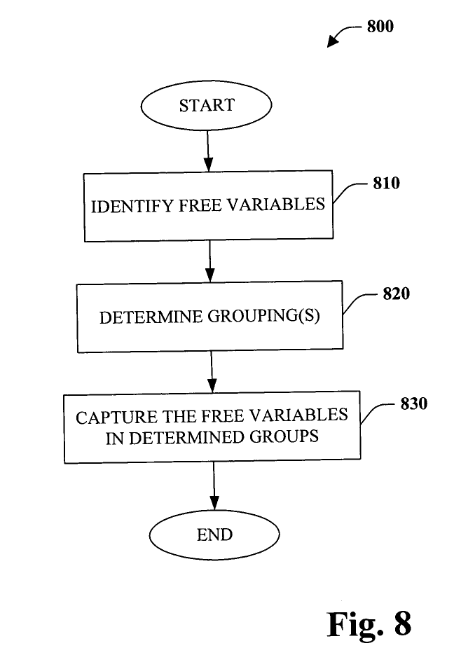

FIG. 8 illustrates a method 800 for capturing free variables. At reference numeral 810, a plurality of free or outer variables are identified within a programmatic construct, such as an expression (e.g., lambda expression). As previously described, a free or outer variables or parameters are declared and/or defined outside a programmatic construct. At 820 groupings or sub-expressions of free variables identified within a programmatic construct are determined. For example, in a minimal grouping, free variables are grouped as individual outer variables. In a maximal grouping or free sub-expression, the group includes the largest possible groups or sub-expressions that are independent of arguments of the programmatic construct or expression. Furthermore, some grouping in between minimal and maximal can be determined appropriate. The groupings can be determined manually, semi-automatically or automatically. For example, heuristics or artificial intelligence can be employed to determine an appropriate grouping base on a variety of factors. At reference 830, the grouped free variables can be captured, for example by reference or value. A variable is captured by value when the value of the variable is substituted for the variable itself. A variable is captured by reference when a variable is replaced by mechanism, method, or reference thereto that can retrieve, return and/or modify or update the value of a variable upon access and/or execution.

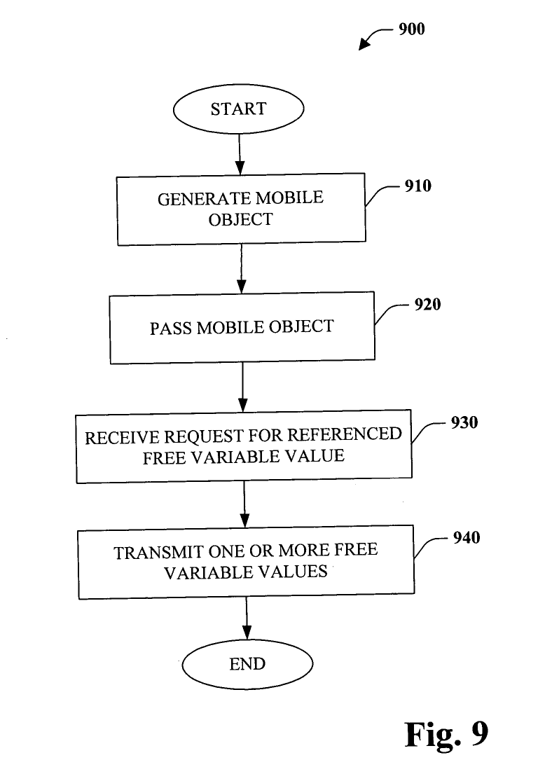

FIG. 9 depicts a mobile object interaction methodology 900. At reference numeral 910, a mobile object is generated. The mobile object could be a data packet transferable between computer systems, processes, environments, and the like. In one instance, the mobile object can take the form of an expression tree. The object or expression tree can include captured free or outer variables. At 920, the mobile object or expression tree is passed or transmitted to another system or environment that can execute the programmatic code specified thereby. At 930, a request is received for a free variable, group, or sub-expression value. At 940, one or more values are modified and/or retrieved, computed, if necessary, and returned or transmitted back to the requesting entity.

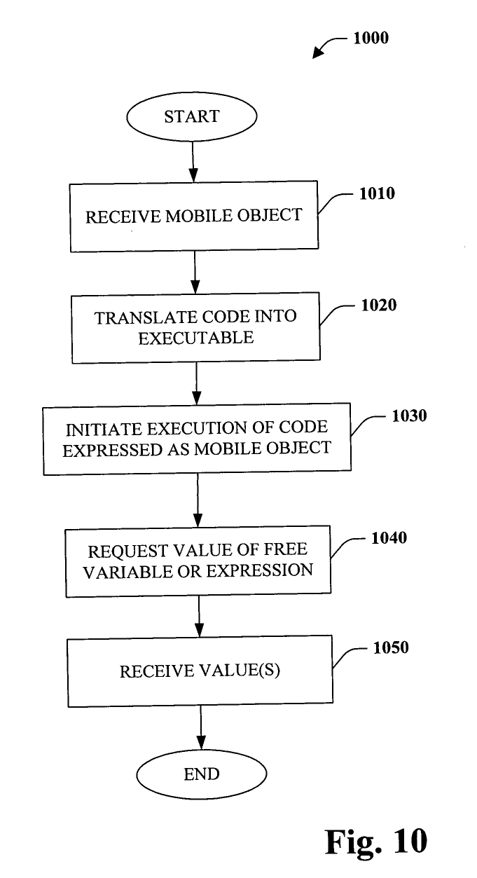

FIG. 10 is a flow chart diagram of a mobile object methodology 1000. At reference 1010, a mobile object or data packet including, for instance, an expression tree is received, retrieved, or otherwise obtained. At 1020, the mobile object or data packet can be translated and/or compiled into an executable or intermediate language. For example, an expression tree can be converted into one or more SQL statements or queries for execution on a database. At 1030, execution of the code is initiated. At 1040, a request is made to retrieve and/or modify the value of a free variable, parameter, sub-expression or grouping captured by reference. In response to a retrieval request at 1040, one or more values can be received at 1050. These values can be employed further in execution of the code.

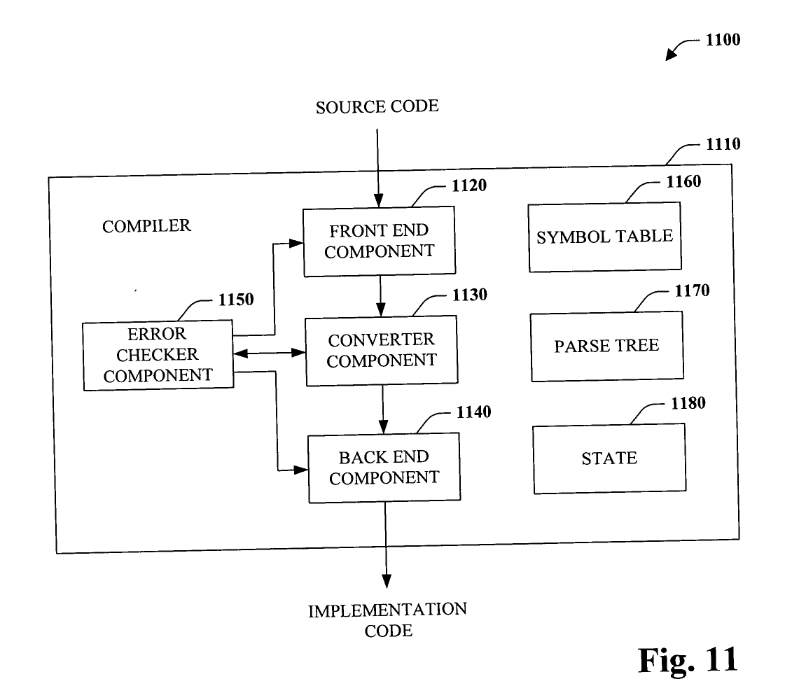

FIG. 11 is a block diagram depicting a compiler environment 1100 that can be utilized in conjunction with various systems, methods, and components provided herein. In particular, compiler environment can produce implementation code (e.g., executable, intermediate language . . . ). The compiler environment 1100 includes a compiler 1110 including front-end component 1120, converter component 1130, back-end component 1140, error checker component 1150, symbol table 1160, parse tree 1170, and state 1180. The compiler 1110 accepts source code as input and produces implementation code as output. The input can include but is not limited to delimited programmatic expressions or qualified identifier as described herein. The relationships amongst the components and modules of the compiler environment illustrate the main flow of data. Other components and relationships are not illustrated for the sake of clarity and simplicity. Depending on implementation, components can be added, omitted, split into multiple modules, combined with other modules, and/or other configurations of modules.

Compiler 1110 can accept as input a file having source code associated with processing of a sequence of elements. The source code may include lambda expressions and associated functions and/or methods and/or mobile code or expression trees. Compiler 1110 may process source code in conjunction with one or more components for analyzing constructs and generating or injecting code.

A front-end component 1120 reads and performs lexical analysis upon the source code. In essence, the front-end component 1120 reads and translates a sequence of characters (e.g., alphanumeric) in the source code into syntactic elements or tokens, indicating constants, identifiers, operator symbols, keywords, and punctuation among other things.

Converter component 1130 parses the tokens into an intermediate representation. For instance, the converter component 1130 can check syntax and group tokens into expressions or other syntactic structures, which in turn coalesce into statement trees. Conceptually, these trees form a parse tree 1170. Furthermore and as appropriate, the converter module 1130 can place entries into a symbol table 1160 that lists symbol names and type information used in the source code along with related characteristics.

A state 1180 can be employed to track the progress of the compiler 1110 in processing the received or retrieved source code and forming the parse tree 1170. For example, different state values indicate that the compiler 1110 is at the start of a class definition or functions, has just declared a class member, or has completed an expression. As the compiler progresses, it continually updates the state 1180. The compiler 1110 may partially or fully expose the state 1180 to an outside entity, which can then provide input to the compiler 1110.

Based upon constructs or other signals in the source code (or if the opportunity is otherwise recognized), the converter component 1130 or another component can inject code to facilitate efficient and proper execution. Rules coded into the converter component 1130 or other component indicates what must be done to implement the desired functionality and identify locations where the code is to be injected or where other operations are to be carried out. Injected code typically includes added statements, metadata, or other elements at one or more locations, but this term can also include changing, deleting, or otherwise modifying existing source code. Injected code can be stored as one or more templates or in some other form. In addition, it should be appreciated that symbol table manipulations and parse tree transformations can take place.

Based on the symbol table 1160 and the parse tree 1170, a back-end component 1140 can translate the intermediate representation into output code. The back-end component 1140 converts the intermediate representation into instructions executable in or by a target processor, into memory allocations for variables, and so forth. The output code can be executable by a real processor, but the invention also contemplates output code that is executable by a virtual processor.

Furthermore, the front-end component 1120 and the back end component 1140 can perform additional functions, such as code optimization, and can perform the described operations as a single phase or in multiple phases. Various other aspects of the components of compiler 1110 are conventional in nature and can be substituted with components performing equivalent functions. Additionally, at various stages of processing of the source code, an error checker component 1 150 can check for errors such as errors in lexical structure, syntax errors, and even semantic errors. Upon detection error, checker component can halt compilation and generate a message indicative of the error.

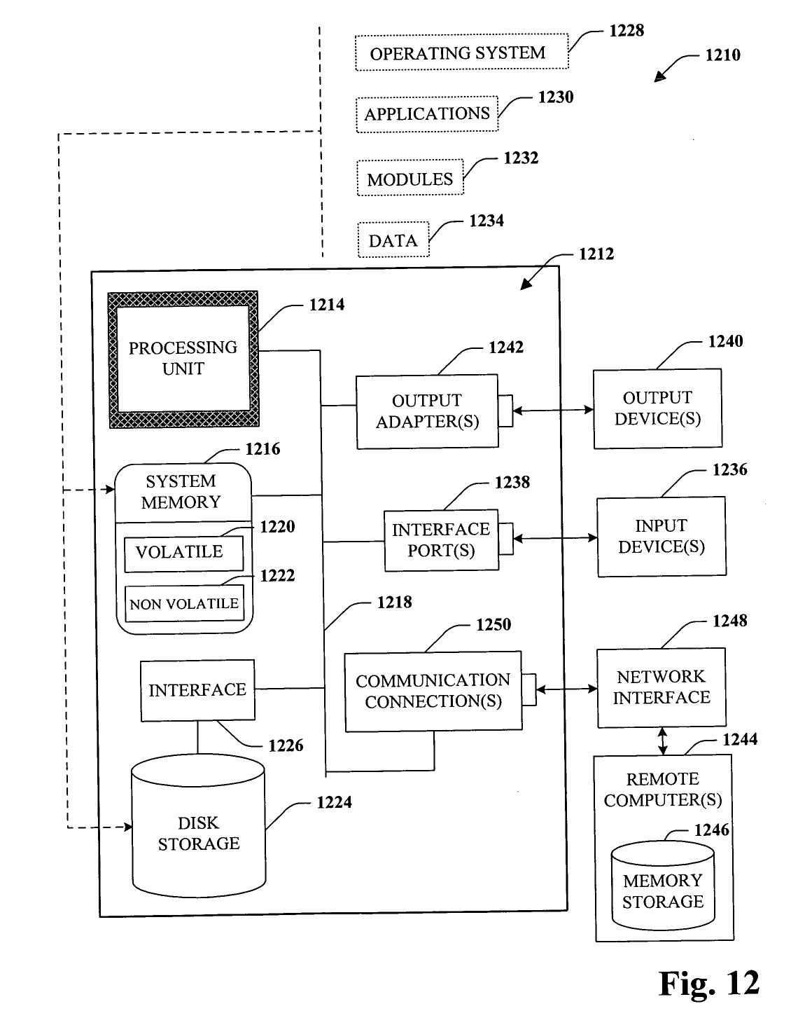

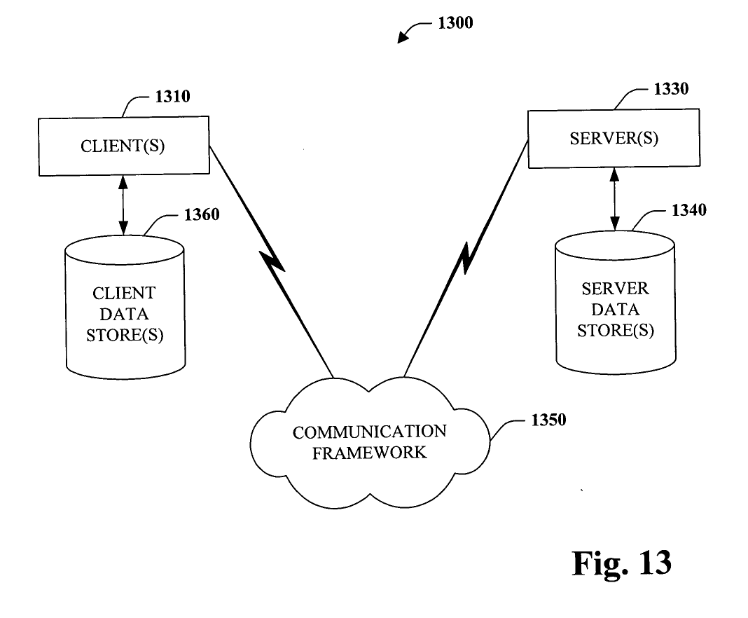

In order to provide a context for the various aspects of the disclosed subject matter, FIGS. 12 and 13 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 12, an exemplary environment 1210 for implementing various aspects disclosed herein includes a computer 1212 (e.g., desktop, laptop, server, hand held, programmable consumer or industrial electronics . . . ). The computer 1212 includes a processing unit 1214, a system memory 1216, and a system bus 1218. The system bus 1218 couples system components including, but not limited to, the system memory 1216 to the processing unit 1214. The processing unit 1214 can be any of various available microprocessors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/non-volatile computer storage media. FIG. 12 illustrates, for example, disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the present invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212 and to output information from computer 1212 to an output device 1240. Output adapter 1242 is provided to illustrate that there are some output devices 1240 like displays (e.g., flat panel and CRT), speakers, and printers, among other output devices 1240 that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems, power modems and DSL modems, ISDN adapters, and Ethernet cards or components.

FIG. 13 is a schematic block diagram of a sample-computing environment 1300 with which the present invention can interact. The system 1300 includes one or more client(s) 1310. The client(s) 1310 can be hardware and/or software (e.g., threads, processes, computing devices). The system 1300 also includes one or more server(s) 1330. Thus, system 1300 can correspond to a two-tier client server model or a multi-tier model (e.g., client, middle tier server, data server), amongst other models. The server(s) 1330 can also be hardware and/or software (e.g., threads, processes, computing devices). The servers 1330 can house threads to perform transformations by employing the present invention, for example. One possible communication between a client 1310 and a server 1330 may be in the form of a data packet adapted to be transmitted between two or more computer processes.

The system 1300 includes a communication framework 1350 that can be employed to facilitate communications between the client(s) 1310 and the server(s) 1330. The client(s) 1310 are operatively connected to one or more client data store(s) 1360 that can be employed to store information local to the client(s) 1310. Similarly, the server(s) 1130 are operatively connected to one or more server data store(s) 1340 that can be employed to store information local to the servers 1330.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A free/outer variable interaction system comprising:
an identification component that identifies at least one free variable specified in an expression; and
a capture component that captures the at least one free variable in the expression.

2. The system of claim 1, the capture component captures a variable by value and the variable is replaced by the value of the variable.

3. The system of claim 1, the capture component captures a variable by reference, the value of the variable is modified and/or retrieved and substituted for the variable, upon evaluation of the expression.

4. The system of claim 1, the capture component further including a group component that captures the one or more free variables in groups or sub-expressions.

5. The system of claim 4, the group component captures one of the largest sub-expression independent of one or more expression arguments, and individual free variables as the smallest group.

6. The system of claim 4, further comprising an intelligence component that interacts with the group component and facilitates selection of a group of free variables via employment of heuristics.

7. The system of claim 1, further comprising an object generation component that generates mobile code that represents the expression.

8. The system of claim 1, the expression is a lambda expression.

9. A computer-implemented method of interacting with free/outer variables comprising:
identifying at least one free variable within the scope of an expression;
capturing the at least one free variable; and
generating an expression tree that represents at least a portion of the expression and at least one captured free variable.

10. The method of claim 9, further comprising transmitting the expression tree to a second system for execution.

11. The method of claim 10, processing the expression in parallel by executing a portion of the expression on a first system and another portion on the second system.

12. The method of claim 10, transmitting the expression tree comprises transmitting the expression tree to one of a database management system and a co-processor.

13. The method of claim 9, capturing at least one free variable includes capturing the at least one variable by value by substituting the value of the variable for the variable upon generating the expression tree.

14. The method of claim 9, capturing at least one free variable comprises capturing at least on free variable by reference to the location of the variable value.

15. The method of claim 14, further comprising at least one of receiving a request for a value of a free variable, retrieving the value, and transmitting it back to a requesting entity, and updating the value of the free variable.

16. The method of claim 9, capturing at least one free variable comprises capturing a sub-expression including a plurality of free variables.

17. The method of claim 16, further comprising receiving a request for a value associated with a sub-expression, retrieving the values of one or more free variables associated with the sub-expression, calculating the value of the sub-expression, and transmitting the calculated value back to a requesting entity.

18. A free variable interaction methodology comprising:
obtaining a data packet that includes a representation of programmatic code and one or more captured free variables; and
initiating execution of the code on a first computer system.

19. The method of claim 18, further comprising:
requesting a value associated with the one or more captured free variables from a second computer system; and
receiving one or more values in response to the request.

20. The method of claim 18, further comprising updating values of the one or more free variables stored on a second computer system.
